(19) United States
(12) Patent Application Publication
(10) Pub. No.: US 2010/0176803 A1
(43) Pub. Date: Jul. 15, 2010

(54) ANGLE SENSOR WITH FLUX GUIDES, ROTATABLE MAGNET AND MAGNETIC SENSOR

(75) Inventor: Udo Ausserlechner, Villach (AT)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: INFINEON TECHNOLOGIES AG, Neubiberg (DE)

(21) Appl. No.: 12/351,990

(22) Filed: Jan. 12, 2009

(51) Int. Cl. G01B 7/30

(52) U.S. Cl. 324/207.25

(57) ABSTRACT

An angle sensor includes first and second flux guides situated in a spaced relationship to define first and second flux guide air gaps therebetween. The first and second flux guides define a central opening, with a magnet situated in the central opening. The magnet is diametrically magnetized and is rotatable relative to the flux guides. A magnetic sensor situated in one of the flux guide air gaps, and is configured to output signals in response to received magnetic flux density.

### BACKGROUND

Devices such as electronic gas pedal position sensors or throttle valve position sensors in automotive applications typically include an angle position detector to determine the position of the associated device. Some systems for angular position sensing, for example in the range of ±70°, include a magnetic circuit that shapes the flux density of a magnet. The magnet is attached to the rotating member in such a way that flux density is generally linearly proportional to the angular position of the magnet, and thus the member to which it is attached. Hence, the magnetic field strength is used to determine the angular position of the movable member. The flux density is measured in any suitable fashion, such as by a linear Hall sensor.

Such systems typically employ a magnet in the shape of a ring. Inside the ring there are two flux guides in the shape of halves of discs, separated by an air-gap in which the Hall-sensors reside. The ring magnet is magnetized in a radial direction throughout one half and in an anti-radial direction in the opposite half. The flux guides collect all flux lines emanating from the magnet and direct them to the Hall sensors. As the magnet rotates, the flux lines move from one flux guide to the other, thus varying the sum of flux lines collected by each flux guide. This results in a generally linear relationship of flux-density versus angle of rotation.

### SUMMARY

One embodiment of an angle sensor includes first and second flux guides situated in a spaced relationship to define first and second flux guide air gaps therebetween. The first and second flux guides define a central opening, with a magnet situated in the central opening. The magnet is diametrically magnetized and is rotatable relative to the flux guides. A magnetic sensor is situated in one of the flux guide air gaps, and is configured to output signals in response to received magnetic flux density.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 illustrates an embodiment of an angle sensing system.

FIGS. 2A-2C illustrate flux lines generated at various angular positions by an embodiment of an angle sensing system.

FIGS. 3A and 3B are plots illustrating flux density vs. angular position and integral nonlinearity, respectively, for the embodiment illustrated in FIG. 2.

FIG. 4 illustrates another embodiment of an angle sensing system.

FIG. 5 is a plot illustrating integral nonlinearity for the embodiment illustrated in FIG. 4.

FIG. 6 illustrates another embodiment of an angle sensing system.

FIG. 7 is a plot illustrating flux-densities vs. angular position for the embodiment illustrated in FIG. 6.

### DETAILED DESCRIPTION

In the following Detailed Description, reference is made to the accompanying drawings, which form a part hereof, and in which is shown by way of illustration specific embodiments in which the invention may be practiced. Regarding embodiments disclosed, the term “exemplary” is merely meant as an example, rather than the best or optimal. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. In addition, while a particular feature or aspect of an embodiment may have been disclosed with respect to only one of several implementations, such feature or aspect may be combined with one or more other features or aspects of the other implementations as may be desired and advantageous for any given or particular application. The following detailed description, therefore, is not to be taken in a limiting sense, and the scope of the present invention is defined by the appended claims.

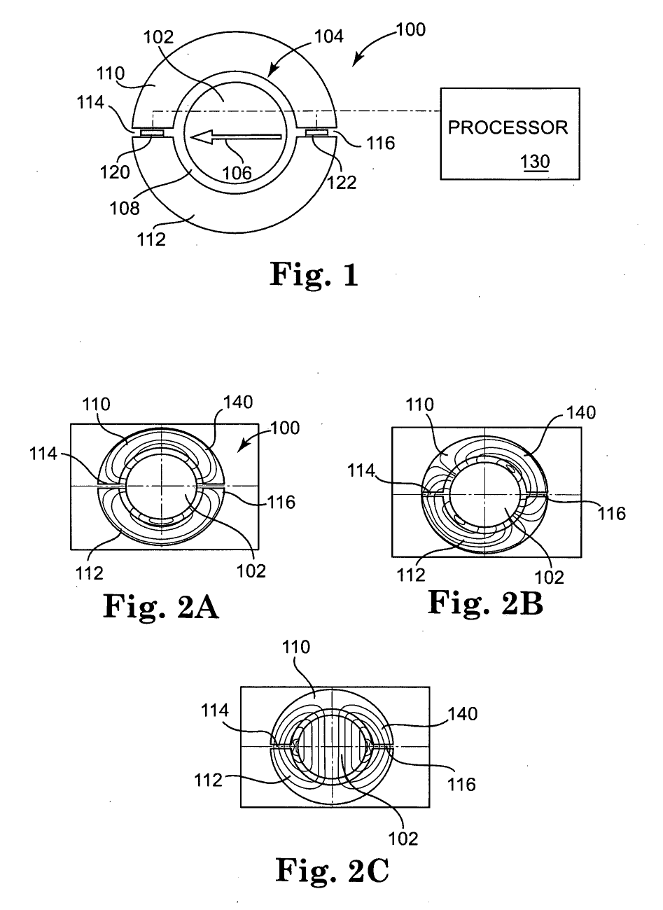

FIG. 1 illustrates an embodiment of an angle sensing system 100 in accordance with the present disclosure. The illustrated sensing system 100 is suitable, for example, in automotive applications such as an electronic gas pedal position sensor. The system 100 includes a magnet 102 that is rotatable. For example, in some implementations, the magnet 102 is attached to move with a rotatable member such as a shaft. The magnet 102 is diametrically magnetized—in the illustrated embodiment, the magnetization points in the in the direction indicated by the arrow 106.

First and second flux guides 110, 112 are situated in a spaced relationship to define first and second flux guide air gaps 114, 116 therebetween. In some embodiments, the flux guides are made of magnetically soft iron. In the illustrated embodiment, the first and second flux guides 110, 112 are generally semicircular, and when positioned together generally form a circle with a central opening or bore 104. With the semicircular flux guides 110,112, the flux guide air gaps 114,116 accordingly are about 180° apart. The magnet 102 is situated in the central opening 104 so as to define an air gap 108 between the flux guides 110,112 and the magnet 102. In the illustrated embodiment, the outer contour of the flux guides 110,112 is also circular, though other shapes for the outer contour can be used in other embodiments, for example, rectangular if that better suits assembly processes. As noted above, the magnet 102 is rotatable in the central opening 104 relative to the flux guides 110,112.

The flux guides 110,112 function to direct the magnetic flux lines from the magnet 102 to the flux guide air gaps 114,116. A magnetic sensor 120 is situated in one of the flux guide air gaps 114,116, and in some embodiments, first and second magnetic sensors 120,122 and situated in the first and second flux guide air gaps 114,116, respectively. Hall sensors, for example, are suitable devices for the magnetic sensors 120,122. As the magnet 102 rotates in the central opening 104, the magnetic flux density reaching the flux guide air gaps 114,116, and thus the magnetic sensors 120,122 varies with the angular position of the magnet 104.

The magnetic sensors 120,122 provide an output signal in response to the received flux density that is received by a processing device 130, which determines the angular position of the magnet 104 in response to the flux density. In general, the processing device 130 may be implemented by one or more of hardware and/or firmware components, such as a microprocessor, an ASIC (application-specific integrated circuit), a DSP (digital signal processor), etc. together with appropriate memory and other necessary devices. For example, in some embodiments, the processing device 130 includes memory storing a look-up table that correlates flux density with angular position.

In the embodiment illustrated in FIG. 1, the magnet 102 has a generally circular cross section. In other embodiments, the magnet 102 has other cross sections. FIGS. 2A-2C illustrate flux lines 140 for various positions of the magnet 102 in an embodiment where the magnet 102 has a circular cross section as in FIG. 1. In FIG. 2A, the magnet 102 is positioned such that the magnetization direction is generally horizontal and aligned with the flux guide air gaps 114, 116, and in FIG. 2C, the magnet 102 is rotated about 900 from the position illustrated in FIG. 2A. FIG. 2B illustrates the magnet 102 at an intermediate position.

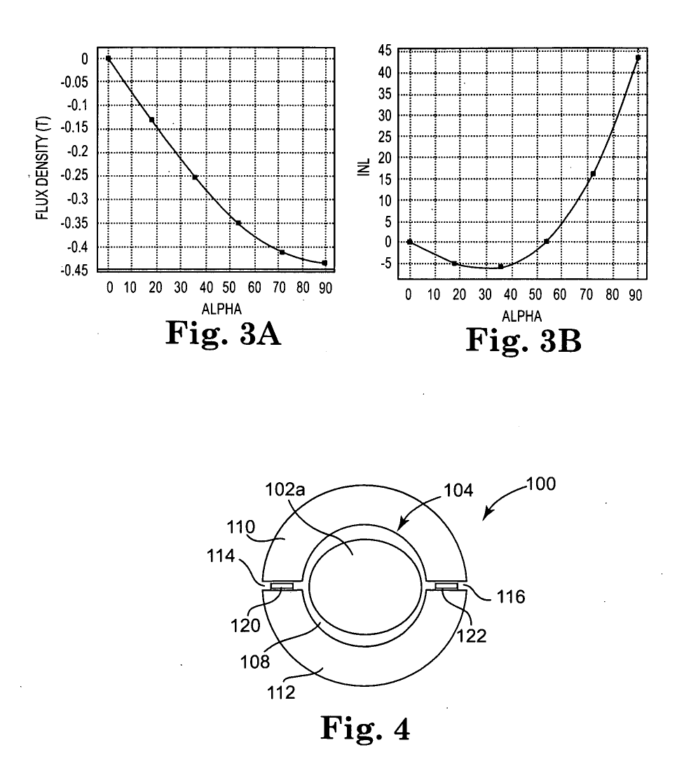

FIG. 3A is a plot illustrating the relationship between flux density and angular position (alpha) for the embodiment illustrated in FIG. 2, and FIG. 3B illustrates the corresponding integral nonlinearity (INL). For the embodiment illustrated in FIG. 2, including the magnet 102 with a circular cross section, the relationship between flux density and angular position begins to significantly deviate from a linear relationship at about alpha=35°. Thus, the embodiment illustrated in FIG. 2 is primarily useful for angular positions from about −35° to +35°—about a 70° range.

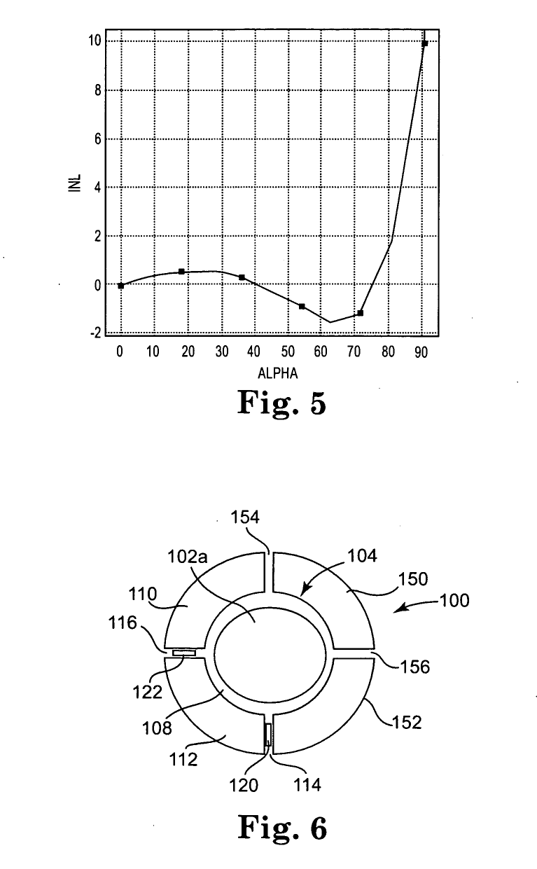

FIG. 4 illustrates another embodiment in which a magnet 102a defining an elliptical cross section is employed. The rest of the structure is essentially the same as the embodiment illustrated in FIG. 1. In some embodiments having an elliptical magnet such as illustrated in FIG. 4, the magnetization extends in the direction of the major axis of the ellipse. The dimensions of the ellipse are chosen to optimize linearity of output signal vs. rotation angle. FIG. 5 illustrates the INL for an embodiment where the magnet 102a has an elliptical cross section with a minor axis of about 16mm and a major axis of about 25 mm. The relationship between flux density and alpha remains linear until about ±75°, resulting in a range of about 150°.

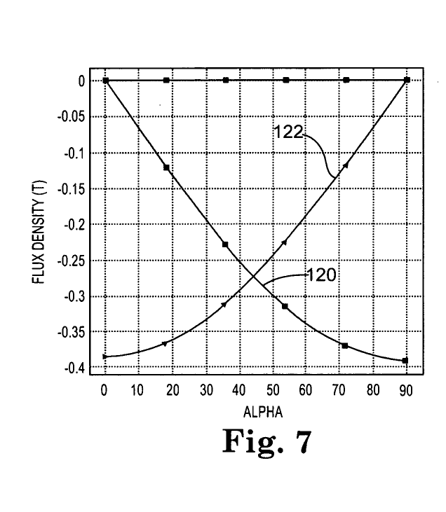

FIG. 6 illustrates another embodiment. In the illustrated version, the magnet 102a defines an elliptical cross section. Third and fourth flux guides 150,152 are included in addition to the first and second flux guides 110,112. Each of the flux guides 110,112,150,152 defines about a quarter circle such that the flux guides together generally form a circle with the central opening 104 where the magnet 102 resides.

The flux guides 110,112,150,152 are spaced apart slightly to define first, second, third and fourth flux guide air gaps 114, 116, 154, 156. The magnetic sensors 120,122 are situated in adjacent flux guide air gaps, for example, the first and second flux guide air gaps 114, 116, which are about 90° apart since each flux guide makes up about a quarter circle.

FIG. 7 illustrates flux-densities vs. angle of rotation for the first and second sensors 120,122. For angular positions from about −45° to about +45°, the first sensor 120 is highly linear, while the second sensor 122 is less accurate. For angular positions from about 45° to about 135° and about −135° to about −45° the second sensor 122 is highly linear and the first sensor 120 is less accurate. Thus, if one of the two sensors fails, the remaining sensor still covers the entire angle range (though with less accuracy), providing redundancy for the system.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. An angle sensor, comprising:
first and second flux guides situated in a spaced relationship to define a first flux guide air gap therebetween, the first and second flux guides situated adjacent a central opening;
a magnet having a generally elliptical cross section with a major axis, the magnet situated in the central opening, the magnet being diametrically magnetized in the direction of the major axis and being rotatable relative to the flux guides; and
a first magnetic sensor situated in the first flux guide air gap, wherein the magnetic sensor is configured to output signals in response to received magnetic flux density.

2. The angle sensor of claim 1, further comprising a second magnetic sensor situated in a second flux guide air gap, wherein the second magnetic sensor is configured to output signals in response to received magnetic flux density.

3. The angle sensor of claim 17, wherein the magnet has a generally circular cross section.

4. The angle sensor of claim 17, wherein the magnet has a generally elliptical cross section.

5. The angle sensor of claim 1, wherein the flux guides are formed from magnetically soft iron.

6. The angle sensor of claim 1, wherein the flux guides are approximately semicircular such that the first and second flux guides together generally form a circle.

7. The angle sensor of claim 1, further comprising:
third and fourth flux guides;
each of the flux guides defining approximately a quarter circle such that the flux guides together generally form a circle
the flux guides being situated in a spaced relationship to define first, second, third and fourth flux guide air gaps;
the first magnetic sensor and a second magnetic sensor being situated in the first and second flux guide air gaps, respectively; and
wherein the first and second flux guide air gaps are approximately 90° apart.

8. The angle sensor of claim 2, wherein the first and second magnetic sensors are Hall sensors.

9. The angle sensor of claim 2, wherein the first and second flux guide air gaps are approximately 180° apart.

10. The angle sensor of claim 2, wherein the first and second flux guide air gaps are approximately 90° apart.

11. The angle sensor of claim 1, further comprising a processing device configured to receive the output signals from the first magnetic sensor and determine an angular position of the magnet in response to the output signals.

12. A method for determining angular position, comprising:
situating first and second flux guides in a spaced relationship to define a first flux guide air gap therebetween, the first and second flux guides situated adjacent a central opening;
situating a first magnetic sensor in the first flux guide air gap, wherein the first magnetic sensor is configured to measure received magnetic flux density;
rotating a magnet in the central opening, the magnet being having a generally elliptical cross section with a major axis and being diametrically magnetized in the direction of the major axis, and being rotatable relative to the flux guides; and
determining the angular position of the magnet in response to the measured flux density.

13. The method of claim 12, further comprising situating a second magnetic sensor in a second flux guide air gap, wherein the second magnetic sensor is configured to measure received magnetic flux density.

14. The method of claim 12, further comprising:
situating third and fourth flux guides in a spaced relationship to define second, third and fourth flux guide air gaps, wherein each of the first, second, third and fourth flux guide air gaps are separated by approximately 90°; and
situating the first magnetic sensor and a second magnetic sensor in the first and second flux guide air gaps, respectively, wherein the first and second flux guide air gaps are approximately 90° apart.

15-16. (canceled)

17. An angle sensor, comprising:
four flux guides situated a generally circular configuration adjacent a central opening;
first, second, third and fourth flux guide air gaps defined by the flux guides, wherein adjacent flux guide air gaps are separated by about 90°;
a magnet situated in the central opening, the magnet being diametrically magnetized and being rotatable relative to the flux guides; and
first and second magnetic sensors configured to output signals in response to received magnetic flux density;
wherein the first and second flux guide air gaps have the first and second magnetic sensors situated therein such that the first and second magnetic sensors are separated by about 90°, and the third and fourth flux guide air gaps do not have magnetic sensors situated therein.

18. The angle sensor of claim 17, wherein the first and second magnetic sensors are Hall sensors.

19. The angle sensor of claim 17, further comprising a processing device configured to receive the output signals from the magnetic sensors and determine an angular position of the magnet in response to the output signals.

20-22. (canceled)

23. The angle sensor of claim 7, wherein the third and fourth flux guide air gaps do not have magnetic sensors situated therein.

24. The method of claim 14, wherein the third and fourth flux guide air gaps do not have magnetic sensors situated therein.
